(19) United States
(12) Patent Application Publication
(10) Pub. No.: US 2013/0188223 A1
(43) Pub. Date: Jul. 25, 2013

(54) SERVER, METHOD FOR CONTROLLING THE SAME, AND PROGRAM

(71) Applicant: CANON KABUSHIKI KAISHA, Tokyo (JP)

(72) Inventor: Yasuharu Sugano, Kawasaki-shi (JP)

(73) Assignee: CANON KABUSHIKI KAISHA, Tokyo (JP)

(21) Appl. No.: 13/745,649

(22) Filed: Jan. 18, 2013

(30) Foreign Application Priority Data
Jan. 23, 2012 (JP) PCT/JP2012/051303

(51) Int. Cl. G06F 3/12

(52) U.S. Cl. CPC G06F 3/1293
USPC 358/1.15

(57) ABSTRACT

An apparatus and method for printing files sent from a portable terminal includes receiving mail with at least one attached file from a portable terminal, associating the at least one received file with a print ID, and sending mail including the print ID to the portable terminal.

### TECHNICAL FIELD

Aspects of the present invention generally relate to technology for printing files sent from portable terminals.

### BACKGROUND ART

A known technology is one for printing a single file stored in the terminal of a cellular phone (PTL 1). In this technology, a cellular phone attaches the single file to a mail which is sent to a server. Then, the server issues a print ID corresponding to the single file, and sends the print ID by means of mail to the cellular phone.

After that, a user who wants to print the single file goes to a printer, and inputs the print ID into the printer. Then, the printer transmits the print ID to the server. The server receives the print ID, and transmits the single file corresponding to the print ID to the printer which finally prints the single file.

### CITATION LIST

### Patent Literature

PTL 1: Japanese Patent Laid-Open No. 2006-191546

In this art, only one file can be printed through one mail transmission. In light of this, embodiments of the present invention are seen to enable multiple files to be printed through one mail transmission.

### SUMMARY OF INVENTION

A server is capable of receiving mail with multiple attached files from a portable terminal. The server includes an associating unit and a sending unit. The associating unit associates the multiple attached files that are received with one print ID. The sending unit sends an electronic mail including the print ID to the portable terminal.

Further features of the present invention will become apparent from the following description of exemplary embodiments with reference to the attached drawings.

### BRIEF DESCRIPTION OF DRAWINGS

FIG. 1 is a block diagram illustrating the exemplary configuration of a print system according to a first embodiment.

FIG. 2 illustrates a process performed in a mobile terminal 110 according to the first embodiment.

FIG. 3 illustrates a process performed when a mail with an attachment is received in a server 120 according to the first embodiment.

FIG. 4 illustrates exemplary records in the server 120 according to the first embodiment.

FIG. 5 illustrates a process performed when a print ID and a password are inquired in the server 120 according to the first embodiment.

FIG. 6 illustrates a process for a print completion notification in the server 120 according to the first embodiment.

FIG. 7 illustrates a process in an image forming apparatus 140 according to the first embodiment.

FIG. 8 illustrates an exemplary UI display displayed when a print ID and a password that are input are not matched in the first embodiment.

FIG. 9 illustrates a process in the mobile terminal 110 according to the first embodiment.

FIG. 10 illustrates a process in the server 120 according to the first embodiment.

### DESCRIPTION OF EMBODIMENTS

An embodiment of the present invention will be described below with reference to the drawings.

### First Embodiment

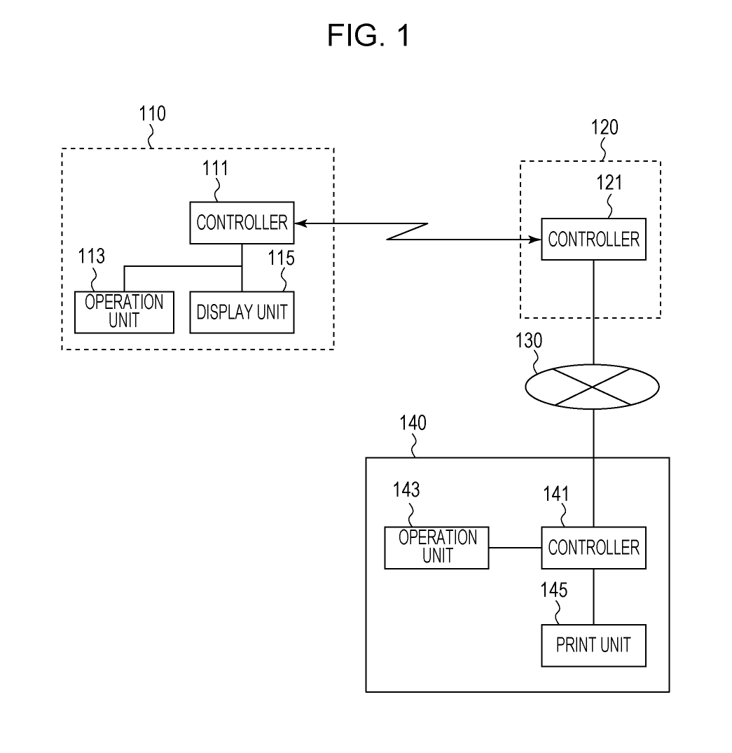

FIG. 1 is a block diagram illustrating the exemplary configuration of a print system according to the present embodiment.

In the print system, a cellular phone terminal (portable terminal) 110 communicates with a server 120 through an electronic mail (hereinafter, referred to as a mail). The server 120 is connected to and communicates with an image forming apparatus 140, which is a printer, via a network such as a WAN 130. According to the present embodiment, the portable terminal 110 and the server 120 may directly communicate with each other via a LAN, or may communicate with each other via one or more servers such as cellular-phone base stations that are located therebetween. The connection between the server 120 and the image forming apparatus 140 is not limited to one through the WAN 130, and may be established via other lines such as a LAN.

The portable terminal (hereinafter, referred to as a mobile terminal) 110 includes a controller 111, an operation unit 113, and a display unit 115, and the controller 111 connects the operation unit 113 and the display unit 115 to each other. The controller 111 includes a CPU, a ROM, a RAM, and a flash memory, and the ROM stores control programs for the controller 111 to control operations of the operation unit 113 and the display unit 115, and programs for the mobile terminal 110 to receive/transmit a mail from/to the server 120. The CPU reads out the control programs stored in the ROM into the RAM, and analyzes and executes them so as to control the operations of operation unit 113 and the display unit 115. In addition, the CPU reads out a mail receiving/sending program stored in the flash memory into the RAM, and analyzes and executes it so as to receive/send a mail. When a mail is to be sent, the controller 111 can attach an electronic file (hereinafter, referred to as a file) stored in the flash memory to the mail, and send the mail in accordance with a user input that is input through the operation unit 113. When a mail is received, the controller 111 controls the display unit 115 so as to display the mail received from the server 120 on the display unit 115. The flash memory stores programs for performing processes indicated by flowcharts described below, and the CPU reads out these programs into the RAM, and analyzes and executes them so as to perform the processes in the flowcharts described below.

The server 120 includes a controller 121 which controls operations of the entire server 120.

The image forming apparatus 140 includes a controller 141 which controls operations of the entire image forming apparatus 140, an operation unit 143 which is a user interface (UI), and a print unit 145 which is an image output device. Like the controller 111 of the mobile terminal 110, these controllers (121 and 141) perform processes by using CPUs, RAMs, ROMs, and flash memories which collaborate with each other. Specific processes which are performed will be described below with reference to the flowcharts.

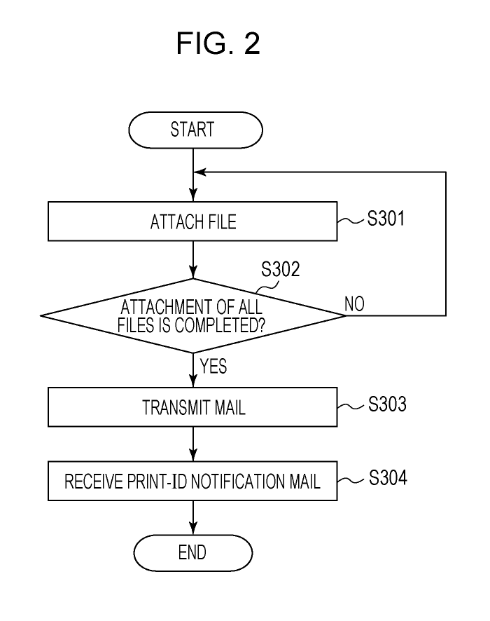

Using the drawings of FIG. 2 and its subsequent figures, processes performed in the present embodiment will be described.

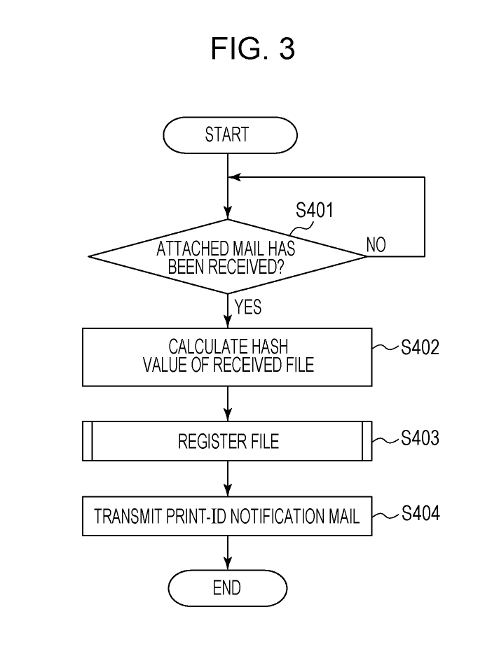

A brief summary will be described. When the mobile terminal 110 attaches one or more files to a mail and sends the mail to the server 120 (S301 to S303), the server 120 stores the files, and transmits one set of a print ID and a password which is used to print the files to the mobile terminal 110 (FIG. 3). Then, the mobile terminal 110 receives the set of a print ID and a password (S304).

Using FIGS. 3, 4, 5, and 6, processes in the server 120 according to the present embodiment will be described in detail.

FIG. 3 is a flowchart of a process performed in the server 120 according to the present embodiment when the server 120 receives a mail with attached files from the mobile terminal 110, and the process is performed by the controller 121.

If a mail which is sent from the mobile terminal 110 and to which one or more files are attached is received (S401), the controller 121 of the server 120 uses a hash algorithm (e.g., SHA256) to calculate a hash value for each of all the files attached to the mail (S402). Here, SHA256 is used as an example of a hash algorithm used for the hash calculation. However, a hash algorithm used in the present embodiment is not limited to this. In addition, in the case where the files described above are constituted by only one file, only one hash value is calculated. In the case where the files described above are constituted by multiple files, multiple hash values are calculated.

The controller 121 generates one print ID and one password. Then, the controller 121 stores the following pieces of data which are associated with each other (S403): (1) the mail address of the mobile terminal, (2) all the received files, (3) all the hash values calculated in S402, (4) the print ID, and (5) the password. The process in S403 may be simply called file registration.

The reason why the server 120 stores hash values along with files is to improve search efficiency when a file is searched for. When a print ID and a password are generated, the controller 121 generates random number sequences having a predetermined number of digits and uses them as a print ID and a password.

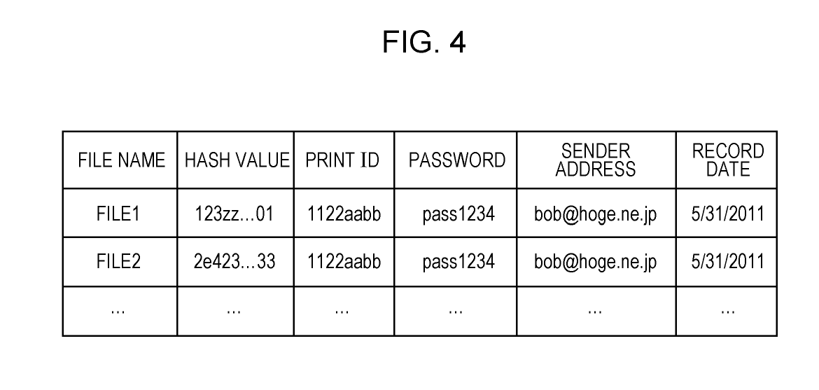

FIG. 4 illustrates exemplary records stored in the controller 121 as a result of file registration. In a record thus stored, the pieces of data (1) to (5) are associated with each other. As is clear from FIG. 4, two files are attached to a mail at a time, which is sent from a mobile terminal 110 having a mail address of “bob@hoge.ne.jp”. The filenames of the files are “file1” and “file2”, and the hash values of the files are “123zz . . . 01” and “2e423 . . . 33”. A print ID and a password that are generated for the files are “1122aabb” and “pass1234”. As is clear from these pieces of data, the files “file1” and “file2” are associated with each other as files having the same print ID.

A set of the following pieces of data may be called one record: (1) the mail address of a mobile terminal, (2) one received file, (3) one hash value calculated in S402, (4) one print ID, and (5) one password.

After the file registration (S403), the controller 121 notifies the mobile terminal 110, which is the sender of the files, of the corresponding set of a print ID and a password by means of a mail (S404). That is, the controller 121 sends a mail including a print ID and a password to the mobile terminal (portable terminal) 110.

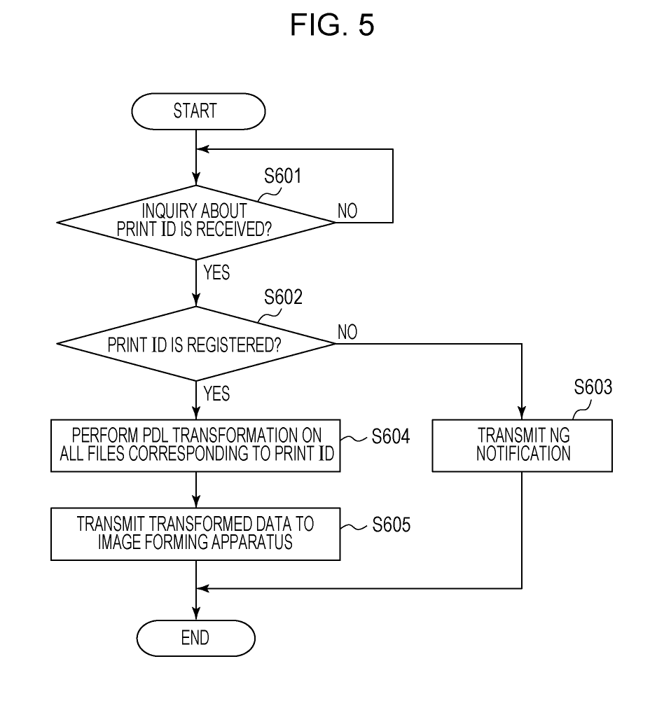

FIG. 5 is a flowchart of a process for an inquiry about a print ID and a password from the image forming apparatus 140, which is performed in the server 120 according to the present embodiment, and the controller 121 performs the process. If an inquiry about a print ID and a password is received from the image forming apparatus 140 (S601), the controller 121 checks if the print ID and the password are registered (stored) in the server 120 (S602). If the check result is that the print ID and the password are not registered, the controller 121 notifies the image forming apparatus 140 that the print ID and the password are not registered (S603). If the print ID and the password are registered, the server 120 performs PDL transformation on all of the files corresponding to the print ID and the password on behalf of image forming apparatus 140 (S604), and transmits the resulting data to the image forming apparatus 140 (S605). The PDL transformation is typically performed by a printer driver, and means that a file is converted into PDL data.

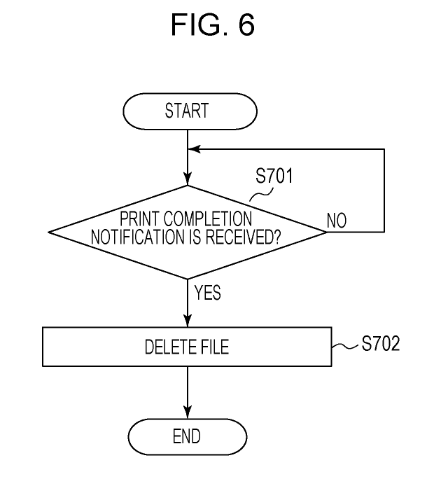

FIG. 6 is a flowchart of a process performed by the server 120 according to the present embodiment after a print completion notification is received from the image forming apparatus 140, and the controller 121 performs the process. If a print completion notification is received (along with the information about a print ID and a password) from the image forming apparatus 140 (S701), the controller 121 deletes the files corresponding to the print ID and the password (i.e., the files associated with the print ID and the password), and the records corresponding to the print ID and the password, from the server 120 (S702). For example, when a print completion notification and pieces of data “1122aabb” and “pass1234” are received, the server 120 deletes the files “file 1” and “file2”, and deletes the first record (the record corresponding to the file “file1”) and the second record (the record corresponding to the file “file2”) in FIG. 4. This results in deletion of both of the files and the print ID, and results in release of the association between the files and the print ID.

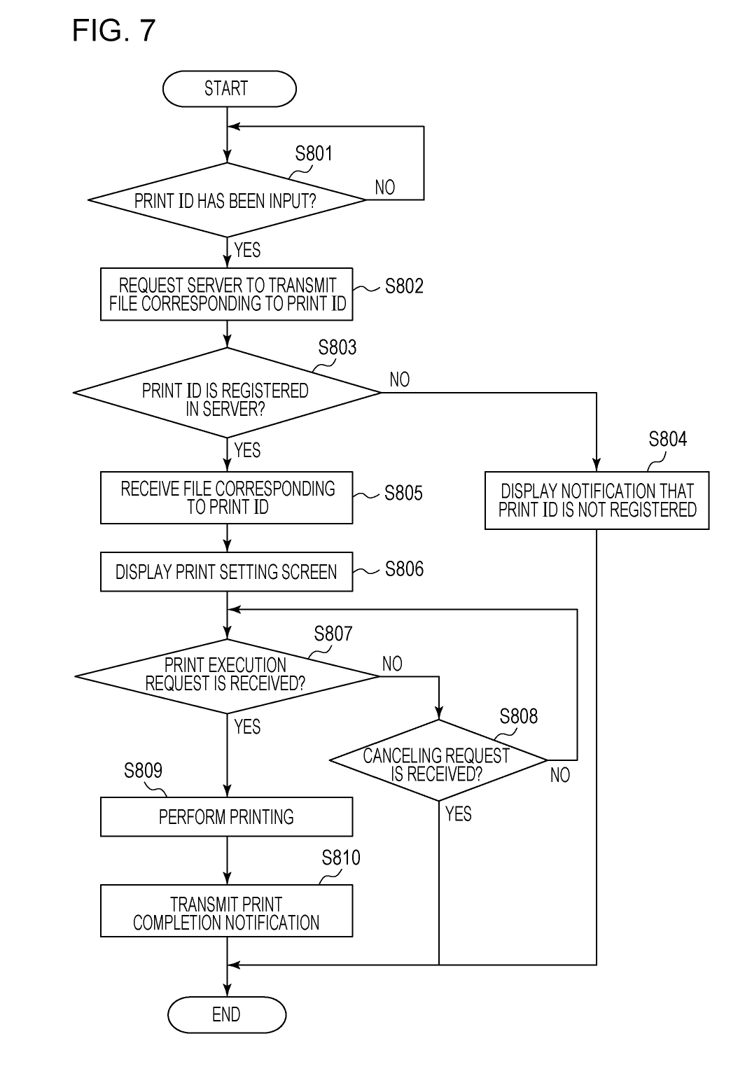

Using FIG. 7, a process in the image forming apparatus 140 according to the present embodiment will be described in detail. FIG. 7 is a flowchart of a process in the image forming apparatus 140 according to the present embodiment, and the controller 141 performs the process.

If a user inputs a print ID and a password through the operation unit 143 (S801), the controller 141 notifies the server 120 of the print ID and the password. This notification indicates that the controller 141 requests files corresponding to the print ID and the password (S802).

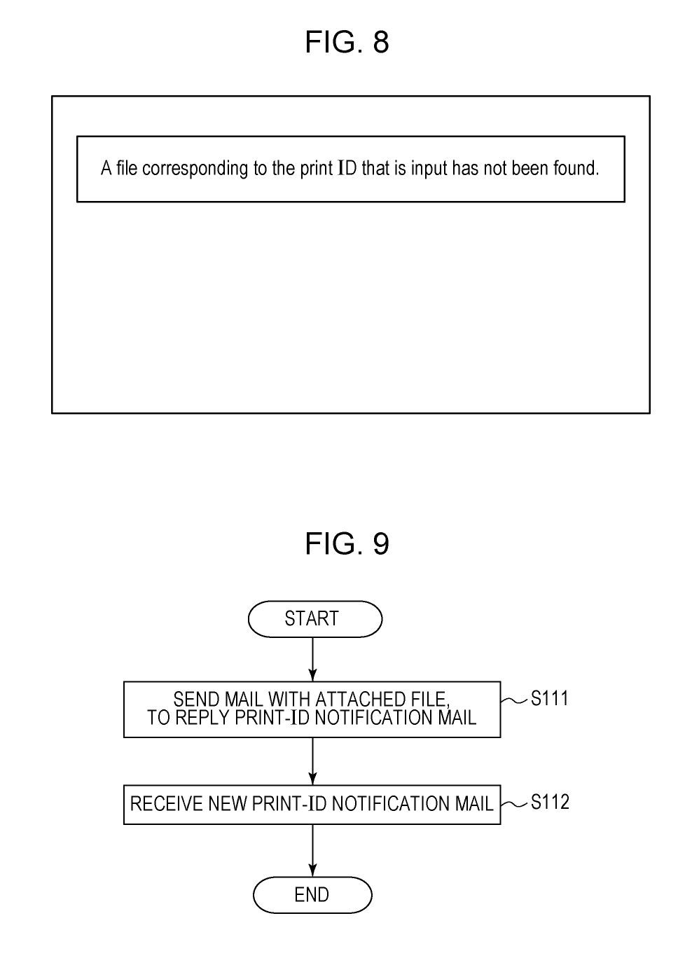

If the print ID and the password are not registered in the server 120 (No in S803), the controller 141 receives a notification that the print ID is not registered. After receiving this notification, the controller 141 causes the operation unit 143 to display a message that the print ID is not registered in the server 120, for example, as illustrated in FIG. 8 (S804). Then, the process for the flowchart is ended.

If the print ID is registered in the server 120 (Yes in S803), the controller 141 receives all of the files corresponding to the print ID and the password from the server 120 (S805).

After that, the operation unit 143 accepts print settings for each of the files from the user (S806). The print settings include, for example, settings of duplex printing, printing in black and white, and stapling. If the operation unit 143 accepts a print execution request issued, for example, by pressing a print start button, from the user (Yes in S807), the controller 141 requests the print unit 145 to perform printing (S809). When a print completion notification is received from the print unit 145, the controller 141 notifies the server 120 that the printing of the files corresponding to the print ID and the password is completed (S810). If the operation unit 143 accepts a canceling request instead of a print request from the user (No in S807 and Yes in S808), the process for the flowchart is ended without performing printing. If the operation unit 143 accepts neither a print request nor a canceling request from the user (No in S807 and No in S808), the process returns back to S807 again.

As described above, a user can associate any files with a set of a print ID and a password. Accordingly, even when multiple files are to be printed, desired image files can be printed only by inputting a set of a print ID and a password into an image forming apparatus.

A process will be described which is performed when one or more additional files are associated to a print ID which has been already associated with one or more files. Similarly, a process will be also described which is performed when association with some files is released.

In the present embodiment, the association among a print ID, a password, and files is changed by returning a mail with attached files from the mobile terminal 110 for a notification mail of the print ID and the password from the server 120.

Using FIG. 9, a process in the mobile terminal 110 will be described. The mobile terminal 110 receives a notification of a print ID and a password (S404). When a user wants to add one or more files corresponding to the print ID and the password, the user uses the operation unit 113 to select the received notification mail for the print ID and the password, and presses a return-mail button. Then, the controller 111 generates a return mail. After that, the user uses the operation unit 113 to attach one or more files to be added, and presses an execution button. The controller 111 sends the return mail with the attached files to the server 120 (controller 121) (S111). Then, the controller 111 receives a new notification mail for the print ID and the password from the server 120 (S112). The return mail with the attached files still includes the print ID and the password.

The addition of files is described as an example, and the process of release of files is similar to that of the addition.

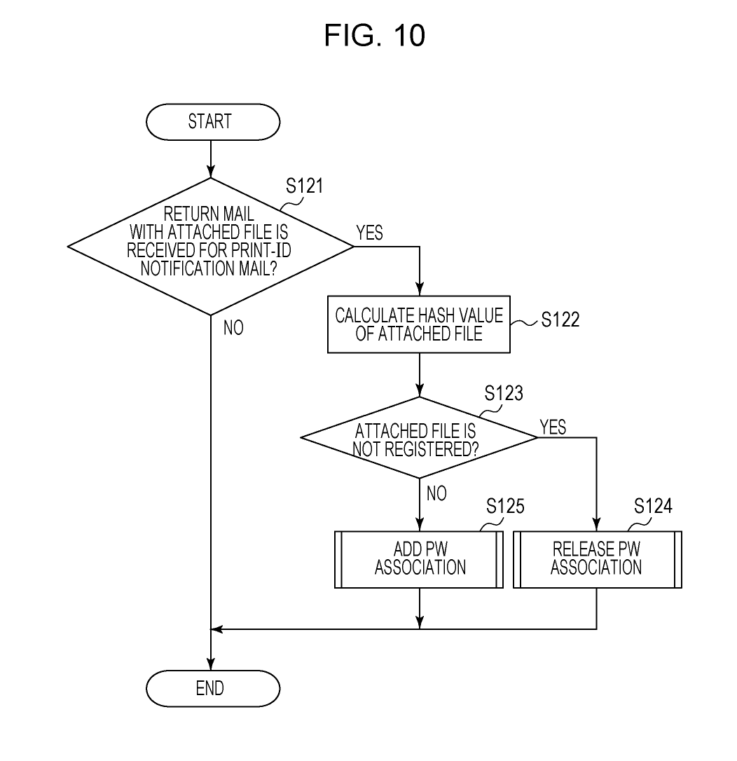

Using FIG. 10, a process in the server 120 according to the present embodiment will be described in detail. FIG. 10 is a flowchart of a process in the server 120 according to the present embodiment.

If a return mail with attached files is received (S121), the controller 121 of the server 120 calculates hash values for the attached files (S122). Then, the controller 121 checks the registration state, i.e., the management state in the server 120, for the attached files on the basis of the calculated hash values (S123).

Specifically, the controller 121 determines whether or not a record corresponding to the print ID included in the return mail with the attached files is present. In the case where multiple files associated to one print ID, such as the files “file1” and “file2” in FIG. 4, are present, multiple records are also present. The controller 121 determines whether or not hash values which match the hash values calculated in S122 are present in these records. If such a hash value is present, it is determined that a file attached to the return mail with the attached files is already registered. In this case, the controller 121 releases the file (S124). If such a hash value is not present, it is determined that a file attached to the return mail with the attached files is a new file which is not registered. In this case, the controller 121 adds the file (S125).

The release of a file means that the record corresponding to the file (file attached to the return mail with the attached files) is deleted. For example, when the file to be released is the file “file1”, the record corresponding to the file “file1” (i.e., the record of “file1”, “123zz . . . 01”, “1122aabb”, “pass1234”, and “bob@hoge.ne.jp”) is deleted and the file “file1” is also deleted.

The addition of a file means that the file and a record corresponding to the file are added. For example, in the case where the print ID included in the return mail with the attached files is “1122aabb” and where an attached file attached to the return mail is a file “file3”, the file “file3” and a record including the following pieces of information are added: “file3”; the hash value for the file “file3”; “1122aabb”; “pass1234”; and “bob@hoge.ne.jp”.

Thus, when a file is added, a record corresponding to the file attached to the return mail is added in such a manner that the record includes the print ID included in the return mail and the password corresponding to the print ID, and the record is stored along with the attached file. This causes the file “file3” to be associated with the files “file1” and “file2” which are already associated with the print ID.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer, for example, via a network or from a recording medium of various types serving as the memory device (e.g., a computer-readable storage medium). In such a case, the system or apparatus, and the recording medium where the program is stored, are included as being within the scope of the present invention.

According to effects of the above-described embodiments, desired image files can be printed by simply inputting one print ID into an image forming apparatus, enabling elimination of a troublesome operation in which a user selects files to be printed, from all of the image files that are registered in a server.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of International Patent Application No. PCT/JP2012/051303, filed Jan. 23, 2012, which is hereby incorporated by reference herein in its entirety.

What is claimed is:

1. A server capable of receiving mail with a plurality of attached files from a portable terminal, the server comprising:
an associating unit configured to associate the plurality of attached files that are received with one print ID; and
a sending unit configured to send an electronic mail including the print ID to the portable terminal.

2. The server according to claim 1, further comprising:
a receiving unit configured to receive the print ID from a printing device based on a user's instruction; and
a unit configured to send the plurality of attached files to an external printing device in a case where the receiving unit has received the print ID from the printing device.

3. The server according to claim 1, wherein
the associating unit associates the plurality of attached files that are received with the print ID and one password; and
the sending unit sends the electronic mail including the print ID and the password to the portable terminal.

4. A server capable of receiving mail with an attached file from a portable terminal, the server comprising:
an associating unit configured to associate the attached file that is received with one print ID; and
a sending unit configured to send mail including the print ID to the portable terminal,
wherein, when mail with a new attached file is received as a return mail for the mail sent by the sending unit, the associating unit further associates the new attached file with the print ID.

5. A method for controlling a server capable of receiving mail with a plurality of attached files from a portable terminal, the method comprising the steps of:
associating the plurality of attached files that are received with one print ID; and
sending mail including the print ID to the portable terminal.

6. A computer-readable storage medium storing a program that causes a computer to execute the method of claim 5.

7. A method for controlling a server capable of receiving mail with an attached file from a portable terminal, the method comprising the steps of:
associating the attached file that is received with one print ID; and
sending mail including the print ID to the portable terminal,
wherein, when mail with a new attached file is received as a return mail for the mail sent in the sending step, the new attached file is further associated with the print ID in the associating step.

8. A computer-readable storage medium storing a program that causes a computer to execute the method of claim 7.
